(19) United States
(12) Patent Application Publication
(10) Pub. No.: US 2007/0064452 A1
(43) Pub. Date: Mar. 22, 2007

(54) Switching power supply and control method thereof

(75) Inventor: Shih-Hsien Chang, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/471,310

(22) Filed: Jun. 20, 2006

(30) Foreign Application Priority Data
Sep. 21, 2005 (TW) 094132729

(51) Int. Cl. H02M 3/335

(52) U.S. Cl. 363/20

(57) ABSTRACT

A switching power supply is provided. The switching power supply includes an auxiliary circuit, a transformer having a primary side connected with said auxiliary circuit in parallel and a secondary side, a main switch having one end connected with the primary side of the transformer and a control terminal, a primary side controller connected with the control terminal of the main switch, a first rectification switch and a second rectification switch coupled with the secondary side of the transformer. The second rectification switch has a control terminal, a secondary side controller having a first end connected with the secondary side of the transformer and a second end connected to the control terminal of the second rectification switch, and a filtering circuit connected to the second rectification switch in parallel. The primary side controller sets a constant interval for each switch-off period of the main switch so as to predict a respective next switch-on time of the main switch, and the secondary side controller switches off the second rectification switch prior to the respective next switch-on time.

### FIELD OF THE INVENTION

The present invention relates to a switching power supply and the control method thereof, and more particularly to a forward or feedback switching power supply and the control method thereof.

### BACKGROUND OF THE INVENTION

In the prior art, a power supply utilizes an AC/DC converter to receive a commercial AC power and convert the commercial AC power into a DC power with a high voltage level. Furthermore, a DC/AC converter is used to convert the DC power with a high voltage level into a DC power with a low voltage level for operating an electronic device. For example, the electronic device can be a desktop computer or a notebook computer.

Typically, the power supply can be classified into two types, a linear power supply and a switching power supply. At present, the switching power supply is the mainstream in the power supply market.

By and large, the switching power supply is composed of an input stage circuit, a power factor correction (PFC) stage circuit, a power stage circuit and a feedback circuit, wherein the PFC stage circuit is the core of the switching power supply.

Please refer to FIG. 1(a) and FIG. 1(b). FIG. 1(a) is a schematic diagram showing the configuration of a power stage circuit of the switching power supply in the prior art, and FIG. 1(b) is a voltage timing diagram for the respective switches in the power stage circuit of the switching power supply of FIG. 1(a), wherein the switching power supply 10 is a forward switching power supply.

In FIG. 1(a), the switching power supply 10 is composed of an auxiliary capacitor Ca, a main switch Q1, an auxiliary switch Q2, a transformer T, a first rectification switch S1, a second rectification switch S2, a filtering inductor L, a filtering capacitor Cb and a driver transformer Tdt.

The operation for the switching power supply 10 in FIG. 1(a) is illustrated as follows. When the main switch Q1 is switched on, an input voltage from the upstream stage (the PFC stage circuit) is supplied to the primary side of the transformer T. After the secondary side of the transformer T senses an energy, the voltage is converted into a DC power via the switch-on first rectification switch S1, and then the ripple of the DC power is filtered by the filtering inductor L so as to output a DC voltage. While the main switch Q1 is switched off, the auxiliary switch Q2 will be switched on, and the voltage polarity on the winding of the transformer is reversed to make the first rectification switch S1 switched off and the second rectification switch switched on. At this time, the stored energy of the filtering inductor L and the filtering capacitor Cb is supplied to the output terminal via the second rectification switch S2.

However, when the auxiliary switch Q2 is switched off, if the second rectification switch S2 is not switched off and then the main switch is switched on, the reverse current will burn down the second rectification switch S2. Hence, the driver transformer Tdt functions to control the main switch Q1 and the second rectification switch S2 so as to first switch off the second rectification switch S2 and then switch on the main switch Q1. There is a dead time (Td) between the timing for switching off the second rectification switch S2 and that for switching on the main switch Q1, as shown in FIG. 1(b).

Although the method using the driver transformer Tdt is prevailing, the cost of the driver transformer Tdt is high so that it is uneasy for the manufacturer to achieve a good cost down. Besides, it is necessary for the control structure of the driver transformer Tdt to cross the primary and secondary sides of the transformer T, which results in a complicated control manner, difficult driving and safety concern during operation.

Please refer to FIG. 2(a) and FIG. 2(b). FIG. 2(a) is a schematic diagram showing the configuration of another power stage circuit of the switching power supply in the prior art, and FIG. 2(b) is a voltage timing diagram for the respective switches in the power stage circuit of the switching power supply of FIG. 2(a). Most of the elements shown in FIG. 1(a) are also shown in FIG. 2(a) where the reference numerals therefor are identical. However, the driver transformer Tdt in FIG. 1(a) is replaced with the N3858V controller designed by NIKO SEMICONDUCTOR, and the control terminal of the main switch Q1 is connected with a fixed frequency controller (not shown) for fixing the cycle Tp of the main switch Q1.

To attain the purpose of first switching off the second rectification switch S2 and then switching on the main switch Q1, the controller N3858V functions to subtract a predetermined dead time Td from the cycle Tp of the main switch fixed by the fixed frequency controller so as to generate a timing for switching off the second rectification switch S2, as shown in FIG. 2(b).

In spite of the improvement to the shortcoming of the circuit structure shown in FIG. 1, the switching power supply 20 in FIG. 2 creates new issue. Firstly, since the cycle Tp of the main switch Q1 remains the same, the switching power supply 20 is good for the electric power apparatus with a fixed frequency and is not applicable to that with a varied frequency. Moreover, such control method and the N3858V controller are applicable only to the forward switching power supply as shown in FIG. 2(a), but not applicable to the feedback switching power supply. This results in an additionally manufactured IC controller having a different control manner from that of the N3858V controller, thereby increasing the production cost.

Please refer to FIG. 3(a) and FIG. 3(b). FIG. 3(a) is a schematic diagram showing the configuration of a further power stage circuit of the switching power supply in the prior art, and FIG. 3(b) is a voltage timing diagram for the respective switches in the power stage circuit of the switching power supply of FIG. 3(a). Most of the elements shown in FIGS. 1(a) and 2(a) are also shown in FIG. 3(a) where the reference numerals therefor are identical However, the controller N3858V in FIG. 2(a) is replaced with a Das03 controller designed by ST MICROELECTRONICS.

To attain the purpose of first switching off the second rectification switch S2 and then switching on the main switch Q1, the controller Das03 functions to detect each switch-on time Ton for the second rectification switch S2, subtract a predetermined dead time Td from the switch-on time Ton, and use the time period (Ton−Td) as the next switch-on time Ton′ for the second rectification switch S2, as shown in FIG. 3(b).

Although the switching power supply 30 in FIG. 3 improves the circuit structure in FIG. 2, which fails to be applicable to the feedback switching power supply, the phase lock loop (PLL) must be used in such control manner and the controller Das03. This results in a higher production cost.

From the above description, it is known that how to develop an improved switching power supply and the control method thereof has become a major problem to be solved. In order to overcome the drawbacks in the prior art, an improved switching power supply and the control method thereof are provided. The particular design in the present invention not only solves the problems described above, but also is easy to be implemented. Thus, the invention has the utility for the industry.

### SUMMARY OF THE INVENTION

In accordance with a first aspect of the present invention, a switching power supply is provided. The switching power supply includes an auxiliary circuit, a transformer having a primary side connected with the auxiliary circuit in parallel and a secondary side, a main switch having one end connected with the primary side of the transformer and a control terminal, a primary side controller connected with the control terminal of the main switch, a first rectification switch and a second rectification switch coupled with the secondary side of the transformer, wherein the second rectification switch has a control terminal, a secondary side controller having a first end connected with the secondary side of the transformer and a second end connected to the control terminal of the second rectification switch, and a filtering circuit connected to the second rectification switch in parallel. The primary side controller sets a constant interval for each switch-off period of the main switch so as to predict a respective next switch-on time of the main switch, and the secondary side controller switches off the second rectification switch prior to the respective next switch-on time.

Preferably, the auxiliary circuit comprises an auxiliary capacitor.

Preferably, the auxiliary circuit further comprises an auxiliary switch.

Preferably, the auxiliary capacitor is connected with the auxiliary switch in series.

Preferably, the auxiliary switch, the main switch, the first rectification switch and the second rectification switch pertain to a semiconductor switch.

Preferably, the filtering circuit comprises a filtering inductor.

Preferably, the filtering circuit comprises a filtering capacitor.

In accordance with a second aspect of the present invention, a switching power supply is provided. The switching power supply includes an auxiliary circuit, a transformer having a primary side connected with the auxiliary circuit in parallel and a secondary side, a main switch having a first end connected with the primary side of the transformer and a control terminal, a primary side controller connected with the control terminal of the main switch, a first rectification switch having a first end coupled with the secondary side of the transformer, a second end and a control end, a secondary side controller having a first end connected with the secondary side of the transformer and a second end connected with the control end of the first rectification switch, and a filtering circuit having a first end connected with the control end of the first rectification switch and a second end connected with the secondary side of the transformer. The primary side controller sets a constant interval for each switch-off period of the main switch so as to predict each next switch-on time of the main switch, and the secondary side controller switches off the first rectification switch prior to each next switch-on time.

Preferably, the auxiliary circuit comprises an auxiliary inductor.

Preferably, the auxiliary circuit further comprises an auxiliary switch.

Preferably, the auxiliary inductor is connected with the auxiliary switch in series.

Preferably, the auxiliary switch, the main switch and the first rectification switch pertain to a semiconductor switch.

Preferably, the filtering circuit comprises a filtering capacitor.

In accordance with a third aspect of the present invention, a control method for a switching power supply containing at least a transformer having a primary side and a secondary side, a main switch coupled to the primary side of the transformer and an output voltage rectification switch coupled to the secondary side of the transformer for a switching power supply is provided. The control method includes steps of setting a constant interval for each switch-off period of the main switch to predict each next switch-on time of the main switch, and switching off the output voltage rectification switch prior to each next switch-on time.

Preferably, the switching power supply is a forward switching power supply.

Preferably, the switching power supply is a feedback switching power supply.

The foregoing and other features and advantages of the present invention will be more clearly understood through the following descriptions with reference to the drawing, wherein:

### BRIEF DESCRIPTION OF THE DRAWINGS

FIG. 1(a) is a schematic diagram showing the configuration of a power stage circuit of the switching power supply in the prior art;

FIG. 1(b) is a voltage timing diagram for the respective switches in the power stage circuit of the switching power supply of FIG. 1(a);

FIG. 2(a) is a schematic diagram showing the configuration of another power stage circuit of the switching power supply in the prior art;

FIG. 2(b) is a voltage timing diagram for the respective switches in the power stage circuit of the switching power supply of FIG. 2(a);

FIG. 3(a) is a schematic diagram showing the configuration of a further power stage circuit of the switching power supply in the prior art;

FIG. 3(b) is a voltage timing diagram for the respective switches in the power stage circuit of the switching power supply of FIG. 3(a);

FIG. 4(a) is a schematic diagram showing the configuration of the power stage circuit of the forward switching power supply according to a preferred embodiment of the present invention;

FIG. 4(b) is a voltage timing diagram for the respective switches in the power stage circuit of the switching power supply of FIG. 4(a);

FIG. 5(a) is a schematic diagram showing the configuration of the power stage circuit of the feedback switching power supply according to a preferred embodiment of the present invention; and

FIG. 5(b) is a voltage timing diagram for the respective switches in the power stage circuit of the switching power supply of FIG. 5(a).

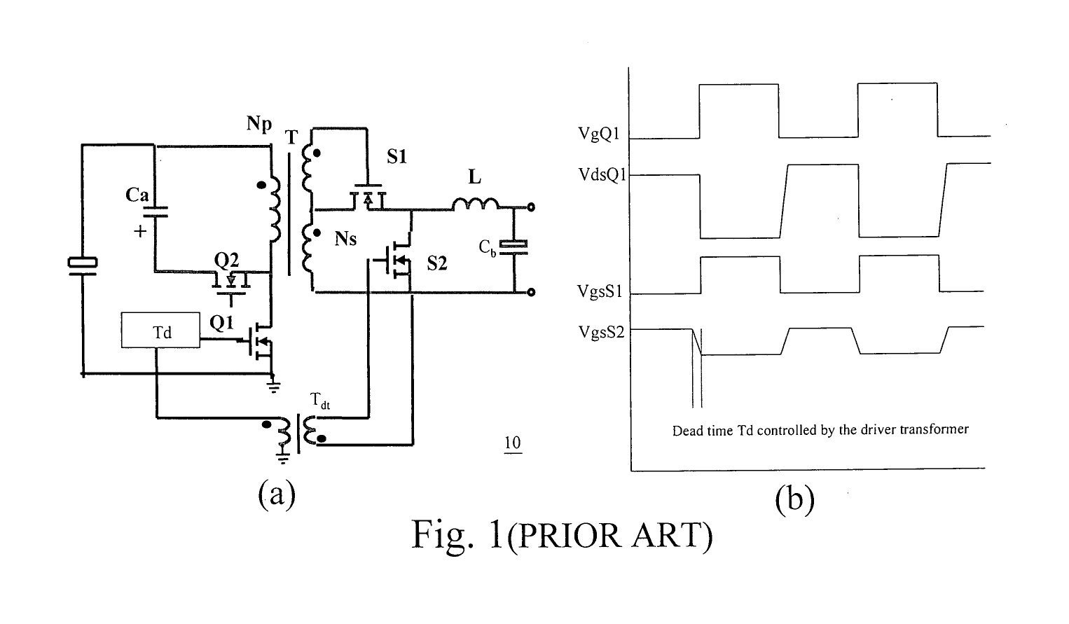

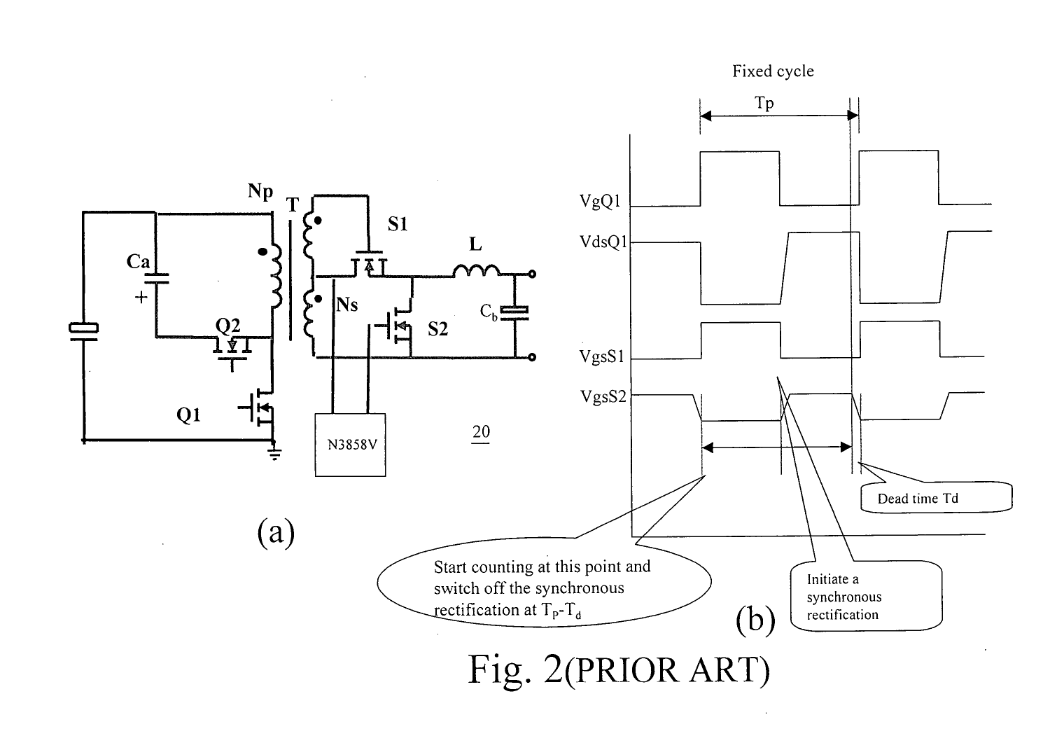

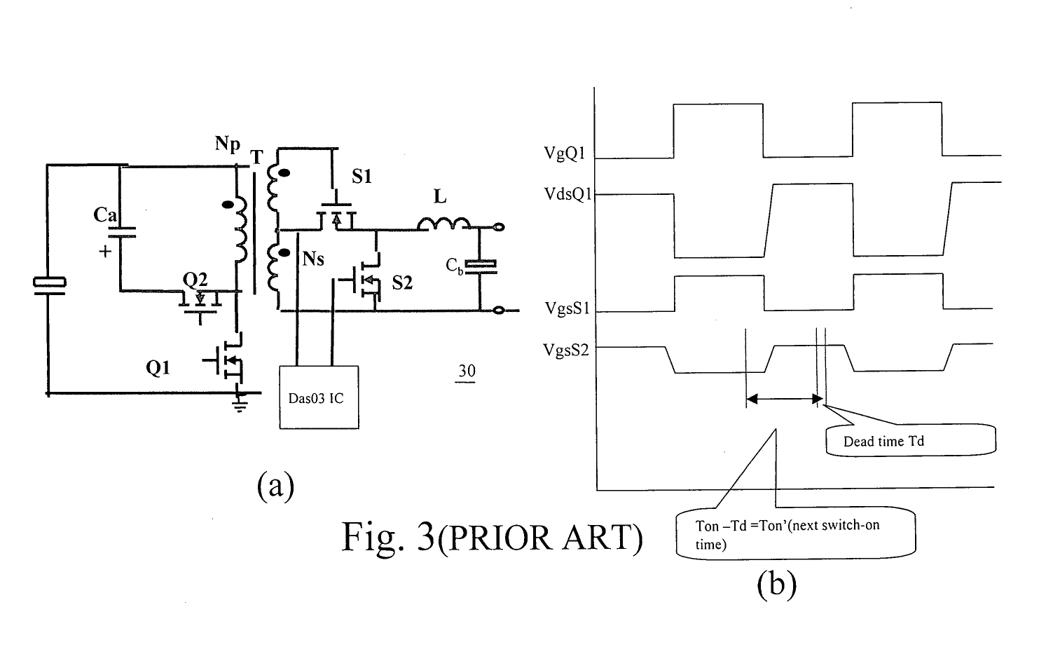

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

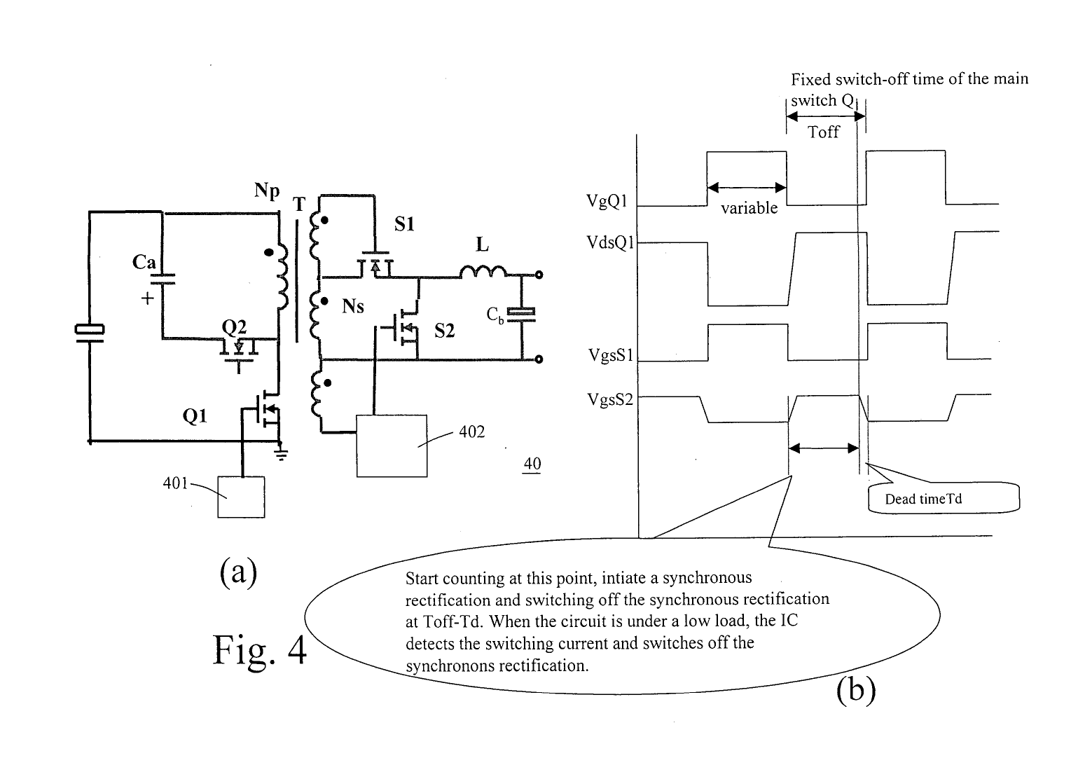

Please refer to FIG. 4(a) and FIG. 4(b). FIG. 4(a) is a schematic diagram showing the configuration of the power stage circuit of the forward switching power supply according to a preferred embodiment of the present invention. FIG. 4(b) is a voltage timing diagram for the respective switches in the power stage circuit of the switching power supply of FIG. 4(a), wherein the switching power supply 40 is a forward switching power supply.

In FIG. 4(a), the switching power supply 40 is composed of an auxiliary circuit containing an auxiliary capacitor Ca and an auxiliary switch Q2, a main switch Q1, a transformer T, a first rectification switch S1, a second rectification switch S2, a filtering circuit containing a filtering inductor L and a filtering capacitor Cb, a primary side controller 401 and a secondary side controller 402.

In FIG. 4(a), the auxiliary capacitor Ca and the auxiliary switch Q2 that are connected in series are connected in parallel with the primary side of the transformer T. One end of the main switch Q1 is connected with the primary side of the transformer T and the other end thereof is connected to the ground and an output terminal. The primary side controller 401 is connected with the control end of the main switch Q1. The first rectification switch S1 and the second rectification switch S2 are coupled to the secondary side of the transformer T. One end of the secondary side controller 402 is connected with the secondary side of the transformer T and the other end thereof is connected with the control terminal of the second rectification switch S2. The filtering inductor L and the filtering capacitor Cb are coupled to both ends of the second rectification switch S2.

To attain the purpose of first switching off the second rectification switch S2 and then switching on the main switch Q1, the control method of the present invention includes the following steps. Firstly, the primary side controller 401 is used to fix each switch-off time Toff of the main switch Q1 (however, each switch-on time of the main switch Q1 may vary) so as to predict the next switch-on time of the main switch Q1. Next, the counting is started by means of the control of the secondary side controller 402 when the second rectification switch S2 is on. Then, the second rectification switch S2 is switched off right after the expiration of the time period when a predetermined dead time Td is subtracted from the switch-off time Toff. Subsequently, the primary side controller 401 switches on the main switch Q1, as shown in FIG. 4(b).

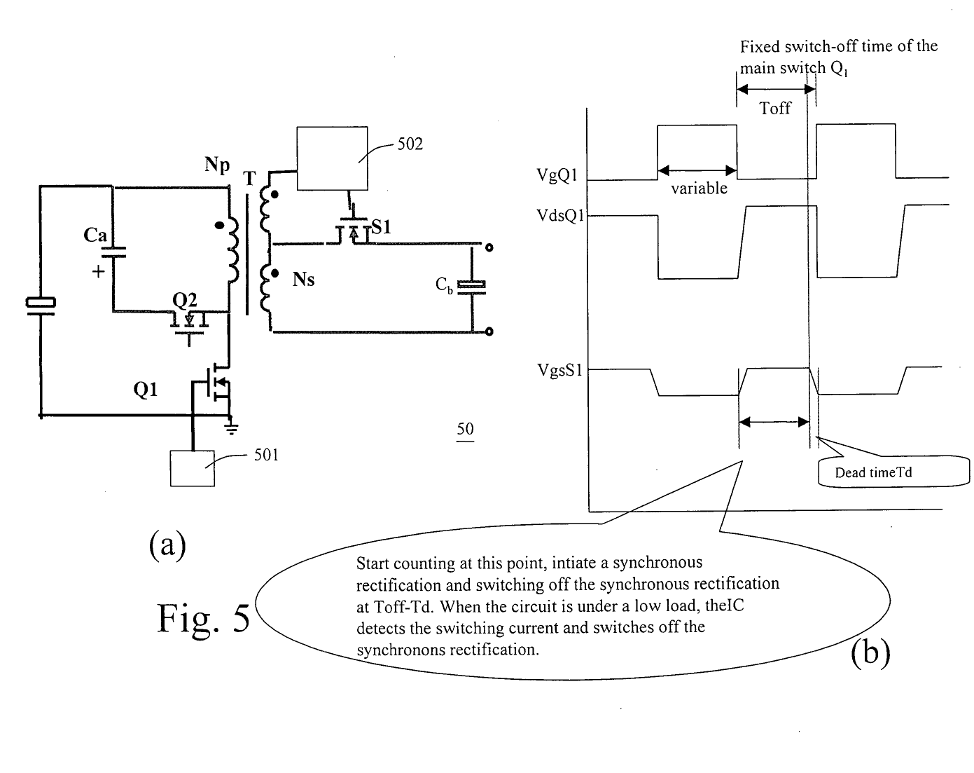

Please refer to FIG. 5(a) and FIG. 5(b). FIG. 5(a) is a schematic diagram showing the configuration of the power stage circuit of the feedback switching power supply according to a preferred embodiment of the present invention, and FIG. 5(b) is a voltage timing diagram for the respective switches in the power stage circuit of the switching power supply of FIG. 5(a), wherein the switching power supply 50 is a feedback switching power supply.

Most of the elements shown in FIG. 4(a) are also shown in FIG. 5(a) where the reference numerals therefor are identical. However, the second rectification switch S2 and the filtering inductor L are removed from FIG. 5, and the secondary side controller 502 is connected with the control terminal of the first rectification switch S1 instead.

The control method of FIGS. 5(a) and 5(b) includes the following steps. Firstly, the primary side controller 501 is used to fix each switch-off time Toff of the main switch Q1 (however, each switch-on time of the main switch may vary) so as to predict the next switch-on time of the main switch. Next, the counting is started by means of the control of the secondary side controller 502 when the first rectification switch S1 is switched on. Then, the first rectification switch S1 is switched off right after the expiration of the time period when a predetermined dead time Td is subtracted from the switch-off time Toff. Subsequently, the primary side controller 501 switches on the main switch Q1, as shown in FIG. 5(b).

In conclusion, by fixing each switch-off time of the main switch at the primary side of the transformer in the switching power supply, the present invention predicts the next switch-on time of the main switch and switches off the output voltage rectification switch at the secondary side of the transformer prior to the next switch-on time of the main switch. The switching power supply of the present invention not only is applicable to the forward and feedback switching power supplies, but also the phase lock loop is unnecessary to be used. The production cost of the present invention is cheaper than those of the conventional switching power supplies. Besides, the voltage stress on the semiconductor switch responsible for controlling in the switching power supply is effectively eliminated.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A switching power supply, comprising:
an auxiliary circuit;
a transformer having a primary side connected with said auxiliary circuit in parallel and a secondary side;
a main switch having one end connected with said primary side of said transformer and a control terminal;
a primary side controller connected with said control terminal of said main switch;
a first rectification switch and a second rectification switch coupled with said secondary side of said transformer, wherein said second rectification switch has a control terminal;
a secondary side controller having a first end connected with said secondary side of said transformer and a second end connected to said control terminal of said second rectification switch; and
a filtering circuit connected to said second rectification switch in parallel, wherein said primary side controller sets a constant interval for each switch-off period of said main switch so as to predict a respective next switch-on time of said main switch, and said secondary side controller switches off said second rectification switch prior to said respective next switch-on time.

2. A switching power supply of claim 1, wherein said auxiliary circuit comprises an auxiliary capacitor.

3. A switching power supply of claim 2, wherein said auxiliary circuit further comprises an auxiliary switch.

4. A switching power supply of claim 3, wherein said auxiliary capacitor is connected with said auxiliary switch in series.

5. A switching power supply of claim 3, wherein said auxiliary switch, said main switch, said first rectification switch and said second rectification switch pertain to a semiconductor switch.

6. A switching power supply of claim 1, wherein said filtering circuit comprises a filtering inductor.

7. A switching power supply of claim 1, wherein said filtering circuit comprises a filtering capacitor.

8. A switching power supply, comprising:
an auxiliary circuit;
a transformer having a primary side connected with said auxiliary circuit in parallel and a secondary side;
a main switch having a first end connected with said primary side of said transformer and a control terminal;
a primary side controller connected with said control terminal of said main switch;
a first rectification switch having a first end coupled with said secondary side of said transformer, a second end and a control end;
a secondary side controller having a first end connected with said secondary side of said transformer and a second end connected with said control end of said first rectification switch; and
a filtering circuit having a first end connected with said control end of said first rectification switch and a second end connected with said secondary side of said transformer, wherein said primary side controller sets a constant interval for each switch-off period of said main switch so as to predict each next switch-on time of said main switch, and said secondary side controller switches off said first rectification switch prior to each said next switch-on time.

9. A switching power supply of claim 8, wherein said auxiliary circuit comprises an auxiliary inductor.

10. A switching power supply of claim 9, wherein said auxiliary circuit further comprises an auxiliary switch.

11. A switching power supply of claim 10, wherein said auxiliary inductor is connected with said auxiliary switch in series.

12. A switching power supply of claim 10, wherein said auxiliary switch, said main switch and said first rectification switch pertain to a semiconductor switch.

13. A switching power supply of claim 8, wherein said filtering circuit comprises a filtering capacitor.

14. A control method for a switching power supply comprising at least a transformer having a primary side and a secondary side, a main switch coupled to said primary side of said transformer and an output voltage rectification switch coupled to said secondary side of said transformer, comprising steps of:
setting a constant interval for each switch-off period of said main switch to predict each next switch-on time of said main switch; and
switching off said output voltage rectification switch prior to each said next switch-on time.

15. The control method of claim 14, wherein said switching power supply is a forward switching power supply.

16. The control method of claim 14, wherein said switching power supply is a feedback switching power supply.
